(19) United States
(12) Patent Application Publication
(10) Pub. No.: US 2004/0026190 A1
(43) Pub. Date: Feb. 12, 2004

(54) Electric brake apparatus

(75) Inventors: Takashi Murayama, Kariya-shi (JP); Daizo Oba, Kariya-shi (JP)

Correspondence Address: BURNS DOANE SWECKER & MATHIS L L P, POST OFFICE BOX 1404, ALEXANDRIA, VA, 22313-1404, US

(73) Assignee: Advics Co., Ltd.

(21) Appl. No.: 10/627,864

(22) Filed: Jul. 28, 2003

(30) Foreign Application Priority Data
Aug. 8, 2002 (JP) 2002-231503
May 21, 2003 (JP) 2003-143141

(51) Int. Cl. F16D 65/36

(52) U.S. Cl. 188/156

(57) ABSTRACT

An electric brake apparatus includes an electric motor which generates a rotational drive force. A gear train is driven by the electric motor and generates a rotational drive force. A screw feed mechanism is driven by the gear train and converts the rotational drive force from the gear train into a linear drive force. A wedge transmission mechanism is driven by the screw feed mechanism and converts the linear drive force from the screw feed mechanism into a linear drive force transverse to the linear drive force from the screw feed mechanism. A piston is driven by the wedge transmission mechanism in an axial direction of the piston and generates a braking force.

### BACKGROUND OF THE INVENTION

1. Field of the Invention

The present invention relates to an electric brake apparatus in which a braking force is generated by the rotational drive force of an electric motor.

2. Description of the Related Art

In one known type of electric brake apparatus, the rotational drive force of the electric motor is converted by a screw feed mechanism into a drive force in the axial direction of a screw shaft of the screw feed mechanism, and the drive force in the axial direction of the screw shaft is converted by a wedge transmission mechanism into a drive force in the axial direction of a piston. The piston is driven by this drive force in its axial direction to generate a braking force. An example of such an electric brake apparatus is disclosed in Japanese Patent Application Laid-Open (kokai) No. 62-127533.

In such an electric brake apparatus, the rotating output shaft of the electric motor and the screw shaft of the screw feed mechanism are disposed in series (coaxially), so the dimensions of the structure comprising the electric motor and the screw feed mechanism measured in the axial direction of the screw shaft become large. As a result, the mountability of the electric brake apparatus may be poor, particularly when the apparatus is mounted on a vehicle having limited mounting space.

### SUMMARY OF THE INVENTION

The present invention was made in order to cope with the above-described problems, and an object of the present invention is to provide an electric brake apparatus which can shorten the axial dimension of a structure comprising an electric motor and a screw feed mechanism, and can improve the mountability of the electric brake apparatus.

The present invention provides an electric brake apparatus including an electric motor which generates a rotational drive force, a gear train which is connected to the electric motor so as to be driven thereby and generate a rotational drive force, a screw feed mechanism which has an input member connected to the gear train so as to be driven thereby and which converts the rotational drive force from the gear train into a linear drive force, a wedge transmission mechanism which is connected to the screw feed mechanism so as to be driven thereby and convert the linear drive force from the screw feed mechanism into a linear drive force transverse to the linear drive force from the screw feed mechanism, and a piston which is connected to the wedge transmission mechanism so as to be driven thereby in an axial direction of the piston and generate a braking force.

In the electric brake apparatus according to the present invention, when the rotating output shaft of the electric motor is rotationally driven during brake operation, the rotational drive force of the electric motor is transmitted to the input member of the screw feed mechanism through the gear train. The rotational drive force is then converted into a drive force in the axial direction of the screw shaft by the screw feed mechanism. The drive force which is converted into the axial direction of the screw shaft by the screw feed mechanism is converted into a drive force in the axial direction of the piston by the wedge transmission mechanism. As a result, the piston is driven in its axial direction in order to generate a braking force, with which a rotating body is braked.

In the electric brake apparatus, the gear train which transmits the rotational drive force of the electric motor to the input member of the screw feed mechanism as a rotational drive force is disposed between the electric motor and the screw feed mechanism. Therefore, by suitably selecting the structure of the gear train, the layout of the electric motor with respect to the screw feed mechanism can be optimized. Accordingly, in this electric brake apparatus, the freedom of installation of the electric motor with respect to the screw feed mechanism can be increased, the axial dimension of the structure comprising the electric motor and the screw feed mechanism can be shortened, and the mountability of the electric brake apparatus can be improved.

In the present invention, preferably, the output shaft of the electric motor and the screw shaft of the screw feed mechanism are disposed side by side. In this case, the electric motor can be compactly arranged with respect to the screw feed mechanism, a decrease in the size of the electric brake apparatus can be achieved, and the mountability of the brake apparatus can be further improved.

In the present invention, preferably, an output gear of the gear train is integrally formed on the input member of the screw feed mechanism. In this case, the number of parts in the electric brake apparatus can be decreased, the size and weight of the electric brake apparatus can be decreased, and the cost of the apparatus can also be decreased.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a cross-sectional side elevation of an electric brake apparatus according to a first embodiment of the present invention;

FIG. 2 is a cross-sectional view showing the relation among the gear train, the screw feed mechanism, the wedge transmission mechanism, the automatic gap adjusting mechanism, the brake pads, and the brake rotor shown in FIG. 1;

FIG. 3 is a cross-sectional side elevation of a main portion of a second embodiment of the electric brake apparatus according to the present invention;

FIG. 4 is a cut-away side elevation of a main portion of a third embodiment of the electric brake apparatus according to the present invention;

FIG. 5 is a cross-sectional side elevation of an electric brake apparatus according to a fourth embodiment of the present invention;

FIG. 6 is a cross-sectional view showing the relation among the gear train, the screw feed mechanism, the wedge transmission mechanism, the automatic gap adjusting mechanism, the brake pads, and the brake rotor shown in FIG. 5; and

FIG. 7 is a cross-sectional side elevation of an electric brake apparatus according to a fifth embodiment of the present invention.

### DESCRIPTION OF PREFERRED EMBODIMENTS

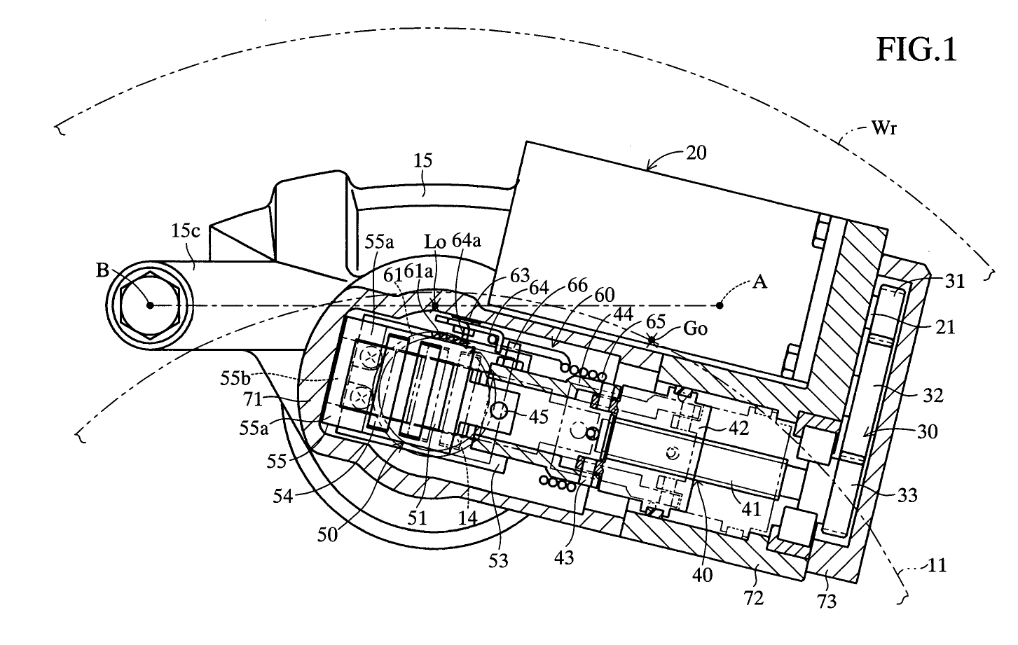

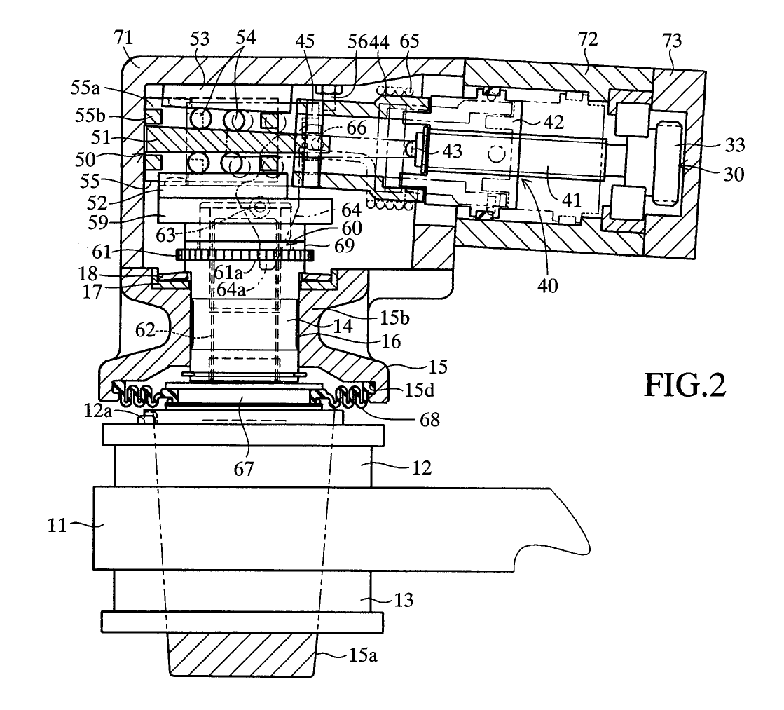

Below, preferred embodiments of the present invention will be described while referring to the accompanying drawings. FIG. 1 and FIG. 2 show a first embodiment of the present invention being employed as an electric disc brake apparatus for a vehicle. The electric disc brake apparatus of the present embodiment includes an inner brake pad 12 and an outer brake pad 13 which can grasp between them a brake rotor 11 which is integral with a wheel (in FIG. 1, the location of the inner diameter of the wheel rim is shown by the imaginary line Wr), and a piston 14 and a caliper 15 which can move the brake pads 12 and 13 in the axial direction of the rotor 11 towards the braking surfaces of the brake rotor 11.

The illustrated electric disc brake apparatus includes an electric motor 20, a gear train 30, a screw feed mechanism 40, and a wedge transmission mechanism 50 for applying a pressing force in the axial direction of the rotor 11 to the piston 14 and the caliper 15. The electric disc brake apparatus also includes an automatic gap adjusting mechanism 60 for automatically adjusting a gap between the brake pads 12 and 13 and the brake rotor 11 during a non-braking state.

As shown in FIG. 2, the inner brake pad 12 can be moved towards and pressed against the brake rotor 11 by the piston 14. The outer brake pad 13 can be moved towards and pressed against the brake rotor 11 by a reaction arm 15a of the caliper 15. Both brake pads 12 and 13 are mounted on a mounting (a support bracket which is omitted from the drawings and which is mounted on the vehicle body) so as to be able to move in the axial direction of the rotor 11. The braking torque at the time of braking is sustained by the mounting.

The piston 14 is mounted on a cylinder portion 15b of the caliper 15 so as to be rotatable and slidable in the axial direction of the cylinder portion 15b via a cylindrical bearing 16, which is made of a solid lubricant or a similar member and permits smooth axial movement and smooth rotation of the piston 14. The piston 14 is biased in the axial direction of the piston away from the brake rotor 11 by means of a Belleville washer 18 which is disposed together with a support plate 17 between the caliper 15 and the piston 14. An adjusting wheel 61, which is an element of the automatic gap adjusting mechanism 60, is integrally provided on the outer circumference of the piston 14, and an adjusting nut 62, which is another element of the automatic gap adjusting mechanism 60, is integrally provided on the inner circumference of the piston 14.

The caliper 15 includes the above-mentioned reaction arm 15a and cylinder portion 15b, and also includes a pair of connecting arms 15c (one of the arms is shown in FIG. 1). The caliper 15 is attached to the mounting through the connecting arm 15c in a manner well known in the art so as to be able to move in the axial direction of the rotor 11. A first housing 71 which primarily houses the wedge transmission mechanism 50, a second housing 72 which primarily houses the screw feed mechanism 40, and a third housing 73 which primarily houses the gear train 30 are integrally attached to the caliper 15.

The electric motor 20 has a rotating output shaft 21 which is rotationally driven in a forward direction in response to an operation of a brake pedal (not illustrated) and which is rotationally driven in the reverse direction in response to release of the brake pedal. The output shaft 21 is mounted on the second housing 72 in such a manner that the output shaft 21 and a screw shaft 41 of the screw feed mechanism 40 are disposed side by side (the output shaft 21 is disposed in approximately parallel to the screw shaft 41 of the screw feed mechanism 40).

The gear train 30 transmits the rotational drive force of the output shaft 21 of the electric motor 20 as a rotational drive force at a reduced speed to the screw shaft 41, which is an input member of the screw feed mechanism 40. The gear train 30 is disposed between the electric motor 20 and the screw feed mechanism 40. The gear train 30 includes an input gear 31 which is secured to the output shaft 21 of the electric motor 20, an intermediate gear 32 which is rotatably supported by the second housing 72 and which always meshes with the input gear 31, and an output gear 33 which is integrally formed on an end of the screw shaft 41 of the screw feed mechanism 40 and which always meshes with the intermediate gear 32. The input gear 31 has a smaller diameter than the output gear 33 and thus can produce a reduction in speed.

The screw feed mechanism 40 converts the rotational drive force of the electric motor 20 into a drive force in the axial direction of the screw shaft 41 and transmits it to the wedge transmission mechanism 50. The screw feed mechanism 40 includes the screw shaft 41 which is rotatably mounted on the second housing 72, a ball nut 42 which has a female-thread portion in engagement with a male-thread portion of the screw shaft 41 and which is disposed in the second housing 72 so as to be able to move in the axial direction of the screw shaft 41 while being prevented from rotating, a connecting sleeve 44 which is integrally connected to the ball nut 42 through a connecting pin 43, and a connecting pin 45 which connects the connecting sleeve 44 and a wedge member 51 of the wedge transmission mechanism 50.

The wedge transmission mechanism 50 converts the drive force in the axial direction of the screw shaft 41 which is transmitted from the screw feed mechanism 40 into a drive force in a direction transverse to the drive force from the screw feed mechanism 40; i.e., in the axial direction of the piston 14, and transmits it to the piston 14. The wedge transmission mechanism 50 includes an outboard plate 52 which is mounted on an end of the piston 14 via a thrust bearing 69 and a base 59, an inboard plate 53 which opposes the outboard plate 52 and is secured to the first housing 71 by use of screws, and the wedge member 51 which is disposed between both plates 52 and 53 and which engages with rollers 54 disposed between the wedge member 51 and the plates 52 and 53.

As shown in FIG. 2, the wedge member 51 has wedge surfaces on its outboard and inboard sides, respectively. Two of the rollers 54 are in rolling contact with each of the wedge surfaces. The wedge surface on the inboard side; i.e., the side facing away from the piston 14 and facing towards the inboard plate 53, is a sloping wedge surface. The outboard plate 52 is secured to the base 59 by use of screws. The outboard plate 52 can move, together with the piston 14, in the axial direction of the piston 14 and can rotate, together with the base 59, about the axis of the piston 14 with respect thereto. The inboard side of the outboard plate 52 (the side facing away from the piston 14) has a flat engaging surface which is parallel to the wedge surface on the outboard side of the wedge member 51. The rollers 54 disposed between the wedge member 51 and the outboard plate 52 are in rolling contact with the opposing parallel surfaces of the wedge member 51 and the outboard plate 52.

The outboard side (the side facing the piston 14) of the inboard plate 53 has a sloping engaging surface which is parallel to the surface of the inboard side (the side facing away from the piston 14) of the wedge member 51. This sloping engaging surface of the inboard plate 53 is in rolling contact with the rollers 54 disposed between it and the wedge member 51. The sloping engaging surface of the inboard plate 53 is roughly parallel to the axial direction of the screw shaft 41 of the screw feed mechanism 40. The direction of movement of the wedge member 51 roughly coincides with the direction of movement of the ball nut 42 and the connecting sleeve 44 of the screw feed mechanism 40 (the axial direction of the screw shaft 41).

The wedge transmission mechanism 50 includes a holder 55 which rotatably holds the rollers 54 and also holds the wedge member 51 so as to allow straight or linear movement in the axial direction of the screw shaft 41. When the wedge member 51 moves linearly, the holder 55 moves in the axial direction of the screw shaft 41 while being guided by the plates 52 and 53. The holder 55 includes a pair of plates 55a which constrain the wedge member 51 and the plates 52 and 53 in a direction roughly perpendicular to the axial direction of the screw shaft 41 (the axial direction of the rollers 54), and four connecting pillars 55b which integrally connect the pair of plates 55a. The amount of movement of the holder 55 in the axial direction of the screw shaft 41 is limited by the first housing 71 and by a stopper bolt 56 secured thereto.

The automatic gap adjusting mechanism 60 includes the above-described adjusting wheel 61 and adjusting nut 62 which are integrally formed on the piston 14. The automatic gap adjusting mechanism 60 also includes an adjusting lever 64 which is rotatably mounted on the first housing 71 via a support pin 63 and which has a pawl 64a formed on an end thereof and engaged with a ratchet tooth 61a of the adjusting wheel 61. A coil spring 65 is disposed so as to engage with the base end of the adjusting lever 64 and engage with the connecting sleeve 44. The spring 65 biases the adjusting lever 64 in the clockwise direction in FIG. 2. A pressing pin 66 is mounted on the connecting sleeve 44 and presses the adjusting lever 64 towards the position shown by solid lines when the connecting sleeve 44 returns to the position shown by solid lines in FIG. 1 and FIG. 2. An adjusting bolt 67 with which the adjusting nut 62 threadingly engages so that the nut 62 can rotate engages with a projection 12a on a backing plate of the inner brake pad 12 so as to be prevented from rotating.

A sealing boot 68 is mounted on the outer periphery of the projecting portion of the adjusting bolt 67. The outer periphery of the boot 68 fits inside and is secured to an annular groove 15d which is formed in the caliper 15. The thrust bearing 69, which is provided between the adjusting wheel 61 and the base 59 supporting the outboard plate 52 of the wedge transmission mechanism 50, enables smooth relative rotation between the base 59 and the adjusting wheel 61. The thrust bearing 69 is rotatably provided on the outer circumference of a cylindrical portion of the piston 14, which portion axially projects by a predetermined amount from an end portion of the piston 14 where the adjusting wheel 61 is provided. The base 59 has an inner hole which is open toward the piston 14, and is attached to the projecting cylindrical portion of the piston 14 in such a manner that the cylindrical portion is rotatably received in the inner hole of the base 59.

In this automatic gap adjusting mechanism 60, when, during braking, the connecting sleeve 44 moves from the position shown by solid lines in FIG. 1 and FIG. 2 to the position shown by imaginary lines, the adjusting lever 64 which is in a retracted position is rotated in the clockwise direction in FIG. 2 through the coil spring 65 by a portion of the drive force in the axial direction of the screw shaft 41 (braking operation input). When the brake pedal is released, the adjusting lever 64 is pressed by the pressing pin 66 and is rotated in the counterclockwise direction in FIG. 2 and returns to its retracted position.

When the adjusting lever 64 is rotated in the clockwise direction in FIG. 2 during brake operation, the pawl 64a of the adjusting lever 64 engages with a ratchet tooth 61a of the adjusting wheel 61 and rotates the adjusting wheel 61. When the adjusting lever 64 is rotated in the counterclockwise direction in FIG. 2 to its retracted position when the brake pedal is released, the pawl 64a of the adjusting lever 64 separates from the ratchet tooth 61a of the adjusting wheel 61, and the adjusting wheel 61 is not rotated.

Therefore, in this automatic gap adjusting mechanism 60, when brake operation takes place, the adjusting wheel 61 is rotated by the adjusting lever 64 and the piston 14 rotates together with the adjusting wheel 61 as a single body. Because of the rotation of the piston 14, the adjusting bolt 67 which is threadingly engaged with the adjusting nut 62 is made to project towards the brake rotor 11, and the gap between the brake pads 12 and 13 and the brake rotor 11 in a non-actuated state is automatically adjusted.

When the amount of return movement of the pawl 64a of the adjusting lever 64 is at least an amount corresponding to the pitch of the ratchet teeth 61a formed on the adjusting wheel 61, the pawl 64a of the adjusting lever 64 engages with the next ratchet tooth 61a when the adjusting lever 64 returns to its retracted position. Therefore, at the time of the next brake operation, the pawl 64a of the adjusting lever 64 engages with the next ratchet tooth 61a and rotates the adjusting wheel 61, so that the above-described gap is adjusted.

In the electric disc brake apparatus of the first embodiment having the above-described structure, when the output shaft 21 of the electric motor 20 is rotatably driven by operation by the brake pedal (not shown), the rotational drive force of the electric motor 20 is transmitted to the screw shaft 41 of the screw feed mechanism 40 through the gear train 30, and the rotational drive force is converted into a drive force in the axial direction of the screw shaft 41 by the screw feed mechanism 40.

The drive force which is converted into the axial direction of the screw shaft 41 in the screw feed mechanism 40 is transmitted to the wedge member 51 from the ball nut 42 through the connecting pin 43, the connecting sleeve 44, and the connecting pin 45. The drive force is converted into a drive force in the axial direction of the piston 14 by the wedge transmission mechanism 50, and the drive force is transmitted to the piston 14 from the outboard plate 52 through the base 59 and the thrust bearing 69.

Therefore, the piston 14 is driven in its axial direction, it pushes the inner brake pad 12 towards the brake rotor 11, and, by its reaction, the reaction arm 15a of the caliper 15 moves the outer brake pad 13 towards the brake rotor 11, and the brake rotor 11 is grasped between the inner brake pad 12 and the outer brake pad 13. As a result, a braking force is generated between the brake pads 12 and 13, and the brake rotor 11, and the brake rotor 11 is braked.

In the electric disc brake apparatus of the first embodiment, the gear train 30 which transmits the rotational drive force of the electric motor 20 to the screw shaft 41 of the screw feed mechanism 40 as a rotational drive force is disposed between the electric motor 20 and the screw feed mechanism 40. Therefore, by suitably selecting the structure of the gear train 30, the layout of the electric motor 20 with respect to the screw feed mechanism 40 can be optimized. Accordingly, in this electric disc brake apparatus, the freedom of installation of the electric motor 20 with respect to screw feed mechanism 40 can be increased. In addition, the axial dimension of the structure comprising the electric motor 20 and the screw feed mechanism 40 can be decreased. As a result, the mountability of the electric disc brake apparatus on a vehicle can be increased.

In the electric disc brake apparatus of the first embodiment, the output shaft 21 of the electric motor 20 and the screw shaft 41 of the screw feed mechanism 40 are disposed side by side (the output shaft 21 of the electric motor 20 is disposed in approximately parallel to the screw shaft 41 of the screw feed mechanism 40). Therefore, the electric motor 20 can be compactly disposed in the shape of a C with respect to the screw feed mechanism 40, a decrease in size of the electric disc brake apparatus can be achieved, and the mountability of the apparatus can be further improved. The output gear 33 of the gear train 30 is integrally formed on the screw shaft 41 of the screw feed mechanism 40, so the number of parts of the electric disc brake apparatus can be decreased, a decrease in the size and weight of the electric disc brake apparatus can be achieved, and costs can also be decreased.

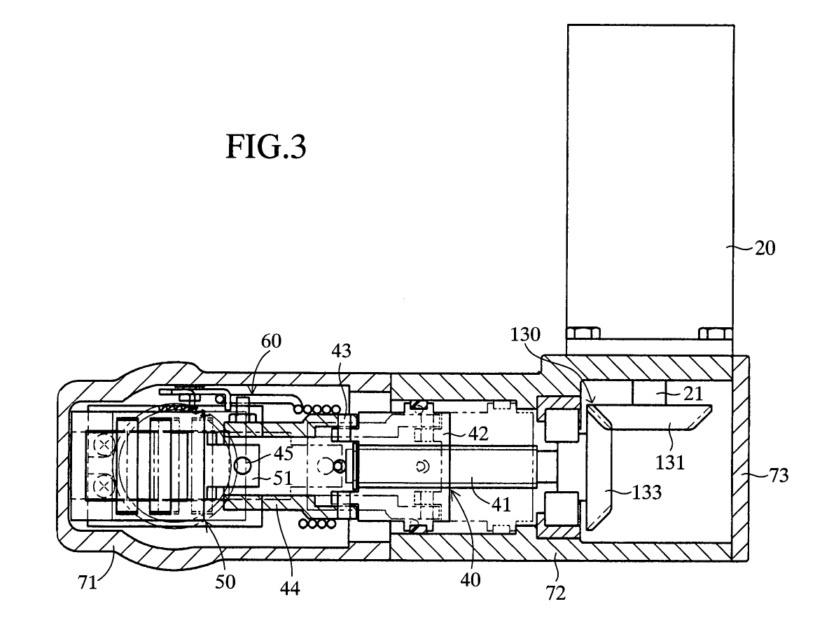

In the first embodiment, spur gears are used so as to constitute the gear train 30. However, as in a second embodiment shown in FIG. 3, bevel gears 131 and 133 may be employed so as to constitute a gear train 130 instead of spur gears. In the second embodiment shown in FIG. 3, the output shaft 21 of the electric motor 20 can be disposed at approximately right angles with respect to the screw shaft 41 of the screw feed mechanism 40.

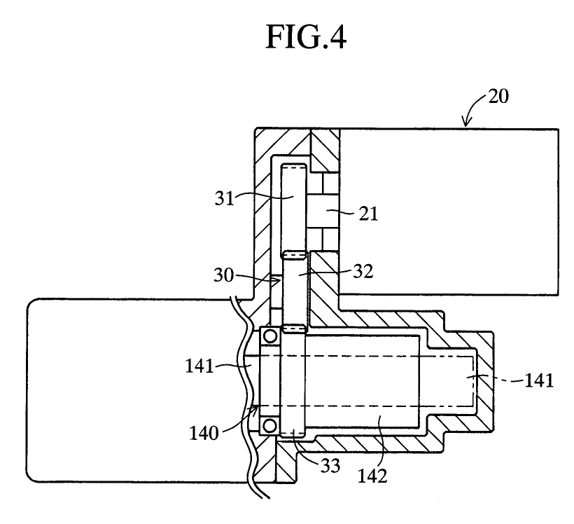

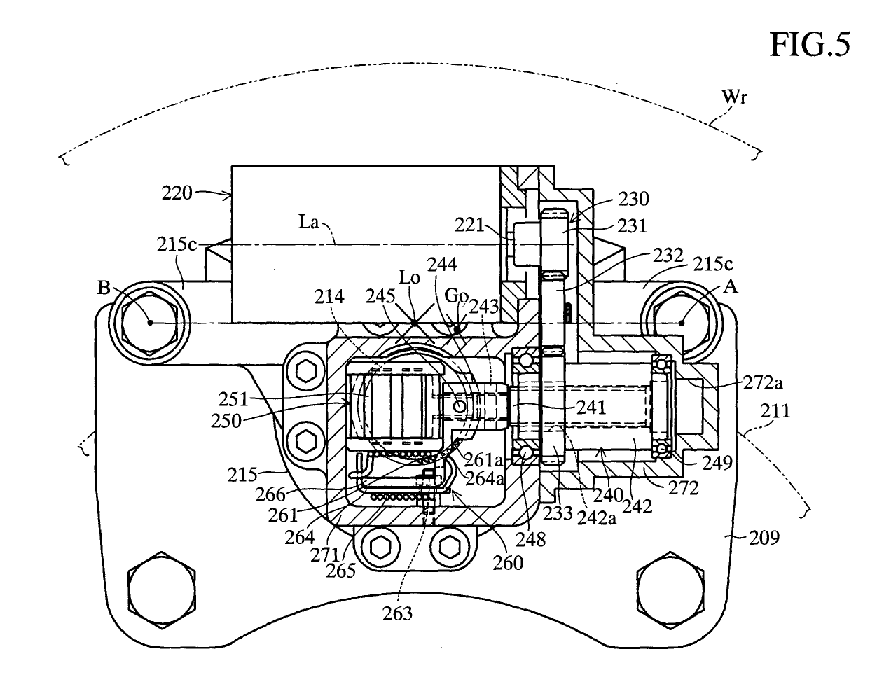

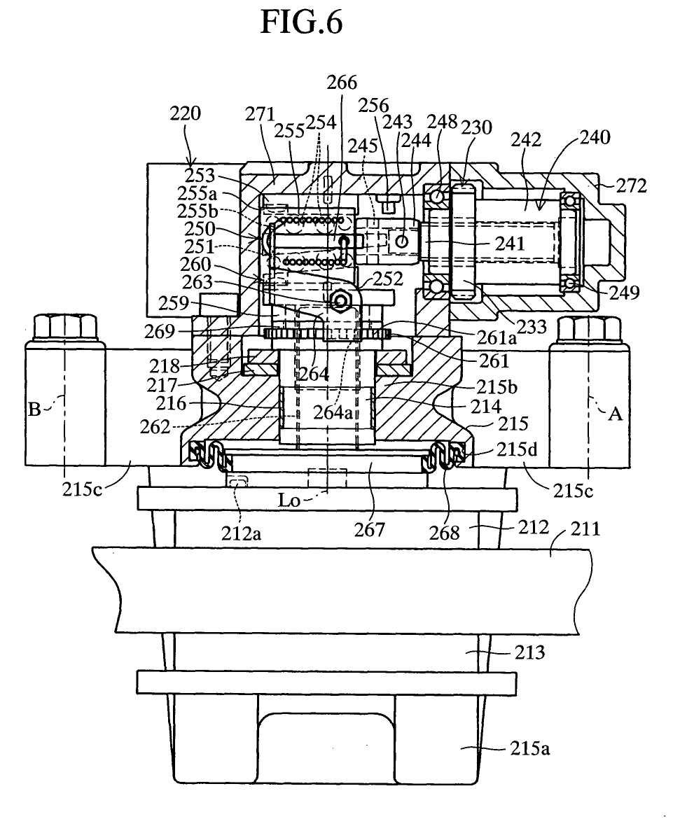

In the first embodiment, the output gear 33 of the gear train 30 is integrally formed on the screw shaft 41 of the screw feed mechanism 40. However, as in a third embodiment shown in FIG. 4 or a fourth embodiment shown in FIG. 5 and FIG. 6, the output gear 33 of the gear train 30 may be integrally formed on a ball nut 142 of a screw feed mechanism 140 or a ball nut 242 of a screw feed mechanism 240.

In the third embodiment shown in FIG. 4, an input member of the screw feed mechanism 140 is the ball nut 142. The ball nut 142 is unable to move in the axial direction of a screw shaft 141 but is able to rotate about the axis of the screw shaft 141, while the screw shaft 141 is able to move in its axial direction while being prevented from rotating. A wedge member of a wedge transmission mechanism (not shown) is drivably connected to the screw shaft 141 so as to be driven in the axial direction of the screw shaft 141 as the screw shaft 141 translates in its axial direction. In the third embodiment as well, the number of parts of the electric disc brake apparatus is decreased, so a decrease in the size and weight of the electric disc brake apparatus can be achieved, and a decrease in cost can be achieved.

FIGS. 5 and 6 show a fourth embodiment of the present invention being employed as an electric disc brake apparatus for a vehicle. The disc brake apparatus of the present embodiment includes an inner brake pad 212 and an outer brake pad 213 which can grasp between them a brake rotor 211 which is integral with a wheel (in FIG. 5, the location of the inner diameter of the wheel rim is shown by the imaginary line Wr), and a piston 214 and a caliper 215 which can move the brake pads 212 and 213 in the axial direction of the rotor 211 towards the braking surfaces of the brake rotor 211.

The illustrated disc brake apparatus includes an electric motor 220, a gear train 230, a screw feed mechanism 240, and a wedge transmission mechanism 250 for applying a pressing force in the axial direction of the rotor 211 to the piston 214 and the caliper 215. The electric disc brake apparatus also includes an automatic gap adjusting mechanism 260 for automatically adjusting a gap between the brake pads 212 and 213 and the brake rotor 211 during a non-braking state.

As shown in FIG. 6, the inner brake pad 212 can be moved towards and pressed against the brake rotor 211 by the piston 214. The outer brake pad 213 can be moved towards and pressed against the brake rotor 211 by a reaction arm 215a of the caliper 215. Both brake pads 212 and 213 are mounted on a mounting 209 shown in FIG. 5 (a support bracket mounted on the vehicle body) so as to be able to move in the axial direction of the rotor 211. The braking torque at the time of braking is sustained by the mounting 209.

The piston 214 is mounted on a cylinder portion 215b of the caliper 215 so as to be rotatable and slidable in the axial direction of the cylinder portion 215b via a cylindrical bearing 216, which is made of a solid lubricant or a similar member and permits smooth axial movement and smooth rotation of the piston 214. The piston 214 is biased in the axial direction of the piston away from the brake rotor 211 by means of a Belleville washer 218 which is disposed together with a support plate 217 between the caliper 215 and the piston 214. An adjusting wheel 261, which is an element of the automatic gap adjusting mechanism 260, is integrally provided on the outer circumference of the piston 214, and an adjusting nut 262, which is another element of the automatic gap adjusting mechanism 260, is integrally provided on the inner circumference of the piston 214.

The caliper 215 includes the above-mentioned reaction arm 215a and cylinder portion 215b, and also includes a pair of connecting arms 215c. The caliper 215 is attached to the mounting 209 through the connecting arms 215c and connecting rods (not illustrated) in a manner well known in the art so as to be able to move in the axial direction of the rotor 211. A first housing 271 which primarily houses the wedge transmission mechanism 250, and a second housing 272 which primarily houses the gear train 230 and the screw feed mechanism 240 are integrally attached to the caliper 215.

As shown in FIG. 5, the electric motor 220 has a rotating output shaft 221 which is rotationally driven in a forward direction in response to an operation of a brake pedal (not illustrated) and which is rotationally driven in the reverse direction in response to release of the brake pedal. The output shaft 221 is mounted on the first housing 271 in such a manner that the output shaft 221 and a screw shaft 241 of the screw feed mechanism 240 are disposed side by side (the output shaft 221 is disposed in approximately parallel to the screw shaft 241 of the screw feed mechanism 240).

The gear train 230 transmits the rotational drive force of the output shaft 221 of the electric motor 220 as a rotational drive force at a reduced speed to the ball nut 242, which is an input member of the screw feed mechanism 240. The gear train 230 is disposed between the electric motor 220 and the screw feed mechanism 240. The gear train 230 includes an input gear 231 which is secured to the output shaft 221 of the electric motor 220, an intermediate gear 232 which is rotatably supported by the first housing 271 and which always meshes with the input gear 231, and an output gear 233 which is integrally formed on the outer circumference of an end of the ball nut 242 of the screw feed mechanism 240 and which always meshes with the intermediate gear 232. The input gear 231 has a smaller diameter than the output gear 233 and thus can produce a reduction in speed.

The screw feed mechanism 240 converts the rotational drive force of the electric motor 220 into a drive force in the axial direction of the screw shaft 241 and transmits it to the wedge transmission mechanism 250. The screw feed mechanism 240 includes the ball nut 242, which is supported by the first housing 271 and the second housing 272 via respective bearings 248 and 249 so as to be rotatable, while being prevented from moving in the axial direction of the screw shaft 241, the screw shaft 241 which has a male-thread portion in engagement with a female-thread portion of the ball nut 242 and which can move in the axial direction of the screw shaft 241 while being prevented from rotating, a connecting sleeve 244 which is integrally connected to the screw shaft 241 through a connecting pin 243, and a connecting pin 245 which connects the connecting sleeve 244 and a wedge member 251 of the wedge transmission mechanism 250.

In the screw feed mechanism 240, a hole 242a is formed in an end portion of the ball nut 242 on the side toward the first housing 271. A portion of the connecting sleeve 244 can be accommodated in the hole 242a. Moreover, a concave portion 272a is formed in the second housing 272 and is open toward the screw shaft 241 side. A portion of the screw shaft 241 can be accommodated in the concave portion 272a.

The wedge transmission mechanism 250 converts the drive force in the axial direction of the screw shaft 241 (linear brake-actuating input) which is transmitted from the screw feed mechanism 240 into a drive force (brake-actuating output) in a direction transverse to the drive force from the screw feed mechanism 240; i.e., in the axial direction of the piston 214, and transmits it to the piston 214. The wedge transmission mechanism 250 includes an outboard plate 252 which is mounted on an end of the piston 214 via a thrust bearing 269 and a base 259, an inboard plate 253 which opposes the outboard plate 252 and is secured to the first housing 271 by use of screws, and the wedge member 251, which is disposed between both plates 252 and 253 and which engages with rollers 254 disposed between the wedge member 251, and the plates 252 and 253.

As shown in FIG. 6, the wedge member 251 has wedge surfaces on its outboard and inboard sides, respectively. Two of the rollers 254 are in rolling contact with each of the wedge surfaces. The wedge surface on the outboard side; i.e., the side facing toward the piston 214 is a sloping wedge surface. The outboard plate 252 is secured to the base 259 by use of screws. The outboard plate 252 can move, together with the piston 214, in the axial direction of the piston 214 and can rotate, together with the base 259, about the axis of the piston 214 with respect thereto. The inboard side of the outboard plate 252 (the side facing away from the piston 214) has a sloping engaging surface 252a which is parallel to the wedge surface 251a on the outboard side of the wedge member 251. The rollers 254 disposed between the wedge member 251 and the outboard plate 252 are in rolling contact with the opposing parallel surfaces of the wedge member 251 and the outboard plate 252.

The outboard side (the side facing the piston 214) of the inboard plate 253 has a flat engaging surface which is parallel to the surface of the inboard side (the side facing away from the piston 214) of the wedge member 251. This flat engaging surface of the inboard plate 253 is in rolling contact with the rollers 254 disposed between it and the wedge member 251. This flat engaging surface of the inboard plate 253 is roughly parallel to the axial direction of the screw shaft 241 of the screw feed mechanism 240. The direction of movement of the wedge member 251 roughly coincides with the direction of movement of the screw shaft 241 and the connecting sleeve 244 of the screw feed mechanism 240 (the axial direction of the screw shaft 241).

The wedge transmission mechanism 250 includes a holder 255 which rotatably holds the rollers 254 and also holds the wedge member 251 so as to allow straight or linear movement in the axial direction of the screw shaft 241. When the wedge member 251 moves linearly, the holder 255 moves in the axial direction of the screw shaft 241 while being guided by the plates 252 and 253. The holder 255 includes a pair of plates 255a which constrain the wedge member 251 and the plates 252 and 253 in a direction roughly perpendicular to the axial direction of the screw shaft 241 (the axial direction of the rollers 254), and four connecting pillars 255b which integrally connect the pair of plates 255a. The amount of movement of the holder 255 in the axial direction of the screw shaft is limited by the first housing 271 and by a stopper bolt 256 secured thereto.

The automatic gap adjusting mechanism 260 includes the above-described adjusting wheel 261 and adjusting nut 262 which are integrally formed on the piston 214. The automatic gap adjusting mechanism 260 also includes an adjusting lever 264 which is rotatably mounted on the first housing 271 via a support pin 263 and which has a pawl 264a formed on an end thereof (output-side end) and engaged with a ratchet tooth 261a of the adjusting wheel 261, and a tension coil spring 265 which urges the adjusting lever 264 in the clockwise direction in FIG. 6.

Moreover, the automatic gap adjusting mechanism 260 includes a pressing arm 266 integrally formed at an end portion of the connecting sleeve 244, and an adjusting bolt 267 with which the adjusting nut 262 threadingly engages so that the nut 262 can rotate. When the connecting sleeve 244 returns to the position shown in FIG. 5 and FIG. 6, the pressing arm 266 presses the adjusting lever 264 towards the illustrated position. The adjusting bolt 267 engages with a projection 212a on a backing plate of the inner brake pad 212 so as to be prevented from rotating.

The coil spring 265 is installed to accommodate a distal end portion of the pressing arm 266. One end of the coil spring 265 is engaged with the pressing arm 266, and the other end of the coil spring 265 is engaged with the input-side end portion of the adjusting lever 264. The coil spring 265 is disposed in such a manner that the line or direction of the pulling action (i.e., the direction of tension) of the coil spring 265 becomes approximately parallel to a plane approximately perpendicular to the axis of the support pin 263, which rotatably supports the adjusting lever 264.

A sealing boot 268 is mounted on the outer periphery of the projecting portion of the adjusting bolt 267. The outer periphery of the boot 268 fits inside and is secured to an annular groove 215d which is formed in the caliper 215. The thrust bearing 269, which is provided between the adjusting wheel 261 and the base 259 supporting the outboard plate 252 of the wedge transmission mechanism 250, enables smooth relative rotation between the base 259 and the adjusting wheel 261. The thrust bearing 269 is rotatably provided on the outer circumference of a cylindrical portion of the piston 214, which portion axially projects by a predetermined amount from an end portion of the piston 214 where the adjusting wheel 261 is provided. The base 259 has an inner hole which is open toward the piston 214, and is attached to the projecting cylindrical portion of the piston 214 in such a manner that the cylindrical portion is rotatably received in the inner hole of the base 259.

In this automatic gap adjusting mechanism 260, when the connecting sleeve 244 moves toward the ball nut 242 during braking, the adjusting lever 264 which is in the illustrated retracted position is rotated in the clockwise direction in FIG. 6 through the coil spring 265 by a portion of the drive force in the axial direction of the screw shaft 241 (brake-actuating input). When the brake pedal is released, the adjusting lever 264 is pressed by the pressing arm 266 and is rotated in the counterclockwise direction in FIG. 6 and returns to the illustrated retracted position.

When the adjusting lever 264 is rotated in the clockwise direction in FIG. 6 during brake operation, the pawl 264a of the adjusting lever 264 engages with a ratchet tooth 261a of the adjusting wheel 261 and rotates the adjusting wheel 261. When the adjusting lever 264 is rotated in the counterclockwise direction in FIG. 6 to its retracted position when the brake pedal is released, the pawl 264a of the adjusting lever 264 separates from the ratchet tooth 261a of the adjusting wheel 261, and the adjusting wheel 261 is not rotated.

Therefore, in this automatic gap adjusting mechanism 260, when brake operation takes place, the adjusting wheel 261 is rotated by the adjusting lever 264 and the piston 214 rotates together with the adjusting wheel 261 as a single body. Because of the rotation of the piston 214, the adjusting bolt 267 which is threadingly engaged with the adjusting nut 262 is made to project towards the brake rotor 211, and the gap between the brake pads 212 and 213 and the brake rotor 211 in a non-actuated state is automatically adjusted.

When the amount of return movement of the pawl 264a of the adjusting lever 264 is at least an amount corresponding to the pitch of the ratchet teeth 261a formed on the adjusting wheel 261, the pawl 264a of the adjusting lever 264 engages with the next ratchet tooth 261a when the adjusting lever 264 returns to its retracted position. Therefore, at the time of the next brake operation, the pawl 264a of the adjusting lever 264 engages with the next ratchet tooth 261a and rotates the adjusting wheel 261, so that the above-described gap is adjusted.

In the electric disc brake apparatus of the fourth embodiment having the above-described structure, when the output shaft 221 of the electric motor 220 is rotatably driven by operation by the brake pedal (not shown), the rotational drive force of the electric motor 220 is transmitted to the ball nut 242 of the screw feed mechanism 240 through the gear train 230, and the rotational drive force is converted into a drive force in the axial direction of the screw shaft 241 by the screw feed mechanism 240.

The drive force which is converted into the axial direction of the screw shaft 241 in the screw feed mechanism 240 is transmitted to the wedge member 251 from the screw shaft 241 through the connecting pin 243, the connecting sleeve 244, and the connecting pin 245. The drive force is converted into a drive force in the axial direction of the piston 214 by the wedge transmission mechanism 250, and the drive force is transmitted to the piston 214 from the outboard plate 252 through the base 259 and the thrust bearing 269.

Therefore, the piston 214 is driven in its axial direction, it pushes the inner brake pad 212 towards the brake rotor 211, and, by its reaction, the reaction arm 215a of the caliper 215 moves the outer brake pad 213 towards the brake rotor 211, and the brake rotor 211 is grasped between the inner brake pad 212 and the outer brake pad 213. As a result, a braking force is generated between the brake pads 212 and 213, and the brake rotor 211, and the brake rotor 211 is braked.

Incidentally, in the electric disc brake apparatus of the fourth embodiment having the above-described configuration, the screw feed mechanism 240 whose screw shaft 241 moves axially upon rotation of the ball nut 242 is employed; the output gear 233 of the gear train 230 is integrally formed on the outer circumference of the end portion of the ball nut 242 located on the side toward the wedge transmission mechanism 250; and the electric motor 220 and the wedge transmission mechanism 250 are disposed side by side (the electric motor 220 is disposed in approximately parallel to the wedge transmission mechanism 250).

Therefore, in the electric disc brake apparatus of the fourth embodiment, as compared to the third embodiment, the dimension of the apparatus as measured along the axis of the screw shaft 241 can be reduced in order to render the apparatus compact. Further, in the electric disc brake apparatus of the fourth embodiment, as shown in FIG. 5, the center of gravity Go of an assembly consisting of the caliper 215 and an actuator consisting of the electric motor 220, the gear train 230, the screw feed mechanism 240, etc. can be made closer to the center axis Lo as compared to the center of gravity Go (the center of gravity of an assembly consisting of the caliper 15 and an actuator consisting of the electric motor 20, the gear train 30, the screw feed mechanism 40, etc.) in the first embodiment shown in FIG. 1. Thus, vibration of the caliper 215 stemming from unsprung vibration can be suppressed. As shown in FIGS. 1, 5, and 6, the center axis Lo is an axis which extends along the axis of the brake rotor (11, 211) while passing through the center of a line extending between the center axes A and B (the center between the center axes A and B) of the connecting rods for connecting the caliper (15, 215) and the mounting (209).

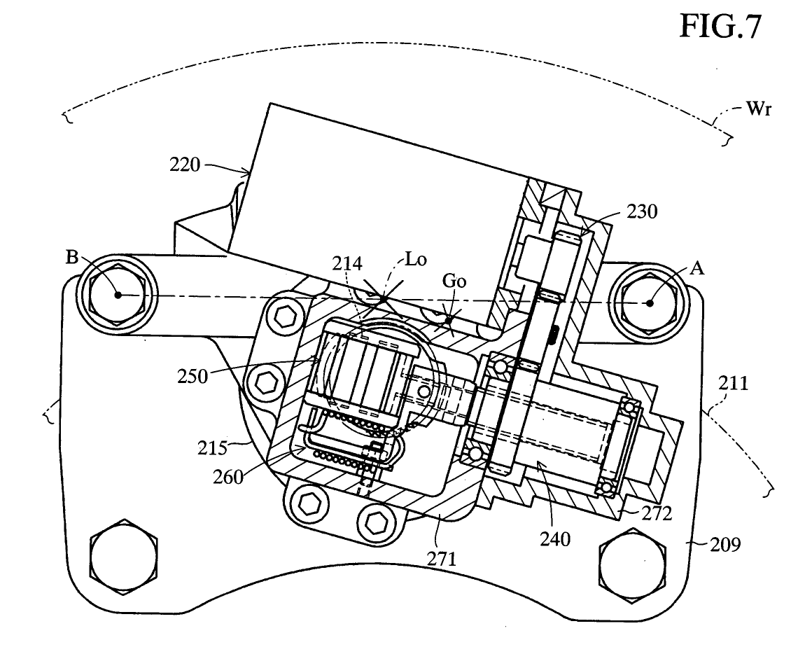

In the electric disc brake apparatus of the fourth embodiment, as shown in FIG. 5, the electric motor 220, the gear train 230, the screw feed mechanism 240, the wedge transmission mechanism 250, etc. are disposed in such a manner that the axis La of the electric motor 220 crosses a line connecting the center axis Lo and the axis of the piston 214 at approximately right angles. However, as in the case of the electric disc brake apparatus of the first embodiment shown in FIGS. 1 and 2 or a fifth embodiment shown in FIG. 7, the electric motor 20 or 220, the gear train 30 or 230, the screw feed mechanism 40 or 240, the wedge transmission mechanism 50 or 250, etc. may be disposed while being inclined clockwise or counterclockwise about the axis of the piston 214 in FIG. 5. When the electric motor 20 or 220, the gear train 30 or 230, the screw feed mechanism 40 or 240, the wedge transmission mechanism 50 or 250, etc. are disposed while being inclined counterclockwise about the axis of the piston 214 in FIG. 5, the above-described center of gravity Go of the assembly including the actuator and the caliper 15 or 215 can be made close to the center axis Lo to a possible extent.

In the above-described embodiments, the present invention was applied to a movable caliper-type disc brake apparatus, but the present invention can of course be applied to other types of disc brake apparatuses. Moreover, the present invention can be applied to a drum brake apparatus in the same manner as in the above-described embodiments or with suitable modifications.

What is claimed is:

1. An electric brake apparatus comprising:
an electric motor which generates a rotational drive force;
a gear train connected to the electric motor so as to be driven thereby and generating a rotational drive force;
a screw feed mechanism having an input member connected to the gear train so as to be driven thereby, the screw feed mechanism converting the rotational drive force from the gear train into a linear drive force;
a wedge transmission mechanism connected to the screw feed mechanism so as to be driven thereby for converting the linear drive force from the screw feed mechanism into a linear drive force transverse to the linear drive force from the screw feed mechanism; and
a piston connected to the wedge transmission mechanism so as to be driven thereby in an axial direction of the piston and generate a braking force.

2. An electric brake apparatus as claimed in claim 1 wherein a rotating output shaft of the electric motor and a screw shaft of the screw feed mechanism are disposed side by side.

3. An electric brake apparatus as claimed in claim 1 wherein the gear train has an output gear which is integrally formed on the input member of the screw feed mechanism.
